(19) United States
(12) Patent Application Publication
(10) Pub. No.: US 2023/0313783 A1
(43) Pub. Date: Oct. 5, 2023

(54) Kitchen Appliance With Detachable Pull String Drive Device

(71) Applicant: SEB S.A., Ecully (FR)

(72) Inventors: Stéphane Plichon, Allonzier-La-Caille (FR); David Benoit, Gruffy (FR)

(73) Assignee: SEB S.A., Ecully (FR)

(21) Appl. No.: 18/007,975

(22) PCT Filed: Jun. 2, 2021
(86) PCT No.: PCT/EP2021/064849

§ 371 Date: Dec. 2, 2022

(30) Foreign Application Priority Data
Jun. 4, 2020 (FR) FR2005874

(51) Int. Cl. F03G 5/06; A47J 43/24; A47J 43/08; A47J 43/044; A47J 43/07

(52) U.S. Cl. CPC F03G 5/065; A47J 43/24; A47J 43/082; A47J 43/044; A47J 43/0727

(57) ABSTRACT

A kitchen appliance includes a self-contained pull string drive device and a work unit. The device is configured for manually rotating a work unit around a rotation axis by pulling a string transversely to the rotation axis A. The device includes a drive wheel, a return spring, all positioned coaxially relative to the rotation axis A, a string, one end of which is wound around the drive wheel and the other end of which is connected to a handle. The work unit includes a lid closing a bowl. The pull string drive device is configured to be detachable from the lid of the bowl. The lid includes a male or female part joined to a drive interface, to cooperate with the drive wheel by mechanical coupling in order to transmit a rotational movement from the device to the work unit.

The field of the invention is that of non-electric, manually-operated, self-retracting cable reels for transmitting movement from one part to another part by pulling a cable or string.

The present invention relates to a kitchen appliance comprising a manually-operated pull string drive device, said drive device being removable and adaptable to various kitchen appliances.

It should be noted that throughout this document, the terms “longitudinal”, “transverse”, “horizontal”, “vertical”, “lower”, “upper”, “top”, “bottom”, “coaxial”, “radial” used to describe the invention, refer to this invention when in use, when placed on a horizontal plane. Within the meaning of the invention, the term “coaxially” denotes that the parts are aligned on a same axis, without necessarily running through the geometric center of the parts.

There are already known pull string drive mechanisms intended to transmit a rotational movement to an object or a work unit. These mechanisms are often used as handheld drive devices in household appliances such as kitchen appliances like salad spinners, choppers, potato mashers, juicers or blenders.

Document US 2008/0164357 discloses a kitchen appliance with a manually-operated pull string. This appliance makes it possible to chop food by rotating cutting blades when the user pulls the handle connected to the string. This chopper is equipped with a manually-operated string drive mechanism positioned inside the lid of the appliance. This drive mechanism is complex to assemble because the parts of the mechanism cooperate with each other and can be put together only while assembling the lid of the kitchen appliance. One of the drawbacks is that once the drive mechanism is positioned in the lid, it is no longer accessible and is permanently joined to the lid in which it is installed. It is therefore impossible to release or move the drive mechanism which is secured in the lid and permanently connected to the lid.

Another drawback is that assembling this kind of drive mechanism in the lid is tedious and complex and cannot be automated. The kitchen appliance assembly therefore cannot be separated from the drive mechanism assembly.

The invention aims to remedy the aforementioned drawbacks and to simplify the assembly of the drive mechanism by creating a self-contained subassembly, separate from the lid that represents the appliance according to the invention. The device of the appliance according to the invention offers the advantage of being readily adaptable to all of the various kitchen appliance shapes and geometries and of being manufactured separately from the rest of the bowl and lid of the kitchen appliance. Accordingly, the device of the appliance according to the invention is separate and ready to operate at any time. The device of the appliance according to the invention is fully accessible because it is not pre-assembled inside the lid, which would restrict its handling. Moreover, the device of the appliance according to the invention has the advantage of being a self-contained, releasable subset, meaning that it is configured to be moveable from one kitchen appliance to another, or even replaceable or repairable. Indeed, it could be foreseen that the pull string drive device of the appliance according to the invention could be released and then moved from one lid to another lid, by releasing it from the bowl lid, without any action on the parts of the drive mechanism or on the tension of the string. The pull string drive device is thus self-contained relative to the lid that closes the bowl of the work unit.

Another advantage of the invention is that the drive device of the appliance according to the invention is designed to be manufactured and transported separately from the rest of the appliance in which it will be used, which represents a substantial degree of industrial autonomy.

Another advantage of the invention is that the work unit can be removed from the drive device and washed separately.

Another advantage of the invention is that the drive device of the appliance according to the invention can be accessed and replaced by removing it from the appliance. This can be very practical for cleaning the kitchen appliance with its lid in a dishwasher, since the drive device can be removed beforehand.

The present invention further aims to remedy the aforementioned drawbacks and to provide a kitchen appliance with a simple, removable, manually-operated pull string drive device that is separate from the rest of the appliance.

The invention relates to a kitchen appliance comprising a self-contained pull string drive device and a work unit; the device is intended for manually rotating a work unit around a rotation axis by pulling a string transversely to the rotation axis A,
the device comprising a drive wheel, a return spring, all positioned coaxially relative to the rotation axis A, a string, one end of which is wound around the drive wheel and the other end of which is connected to a handle;
the work unit comprising a lid closing a bowl;
   characterized in that the pull string drive device is configured to be detachable from the lid of the bowl and in that the lid comprises a male or female part joined to a drive interface, so as to cooperate with the drive wheel by mechanical coupling in order to transmit a rotary movement from the device to the work unit.

The pull string drive device is self-contained so the work unit, including a lid closing a bowl and the bowl, can be washed separately from the drive device. The device is designed and configured to be separate from the lid of the bowl on the work unit. Thus, the device can be adapted to lids of different shapes, sizes and diameters, as well as to bowls of different shapes, sizes and diameters. The device is configured to be versatile. Advantageously, the food present in the work unit is never in contact with the pull string drive device as the lid forms an interface between the motor part of the appliance and its food-holding part. Furthermore, since the male or female part is joined to the drive interface, no food is drawn up to the manual motor.

The appliance according to the invention may additionally have one or more of the following characteristics, taken alone or in combination.

According to another characteristic of the invention, the pull string drive device of the appliance according to the invention is designed and configured to be releasable, attachable or detachable from the lid of the bowl. It can be adapted to different kitchen appliances to transmit a rotational movement, as these kitchen appliances can vary in shape and capacity.

According to one embodiment of the invention, the appliance according to the invention has a fastening system enabling the pull string drive device to be temporarily and reversibly fastened to the lid closing the bowl of the work unit. Thus, the pull string drive device of the appliance according to the invention is designed and configured to be self-contained, meaning that it can be freely removed from the lid.

The system for fastening the pull string drive device of the appliance according to the invention is adapted to enable the user to freely connect the device to the work unit and disconnect it therefrom. The device can thus be removed or released from the lid of the bowl on the work unit. The device is removably fastened to the interface between the motor part of the appliance and its food-holding part. “Removable” means that the user can freely take it off and put it back on, without disassembling it, temporarily or not.

According to another characteristic of the invention, the fastening system of the drive device cooperates with a fastening member positioned on the lid closing the bowl of the appliance. Thus, this fastening member is designed and configured to temporarily secure the drive device to the lid and thus hold the drive device on the lid. This hold is reversible.

According to another characteristic of the invention, the fastening system of the pull string drive device of the appliance according to the invention is a bayonet fastening system in which the drive device has means that cooperate with equivalent means placed on the work unit. To fasten it with such bayonet systems, the pull string drive device must be placed above the work unit and must rotate to the closed position and inversely to the open position. The interlocking bayonets ensure that the pull string drive device is secured to the work unit. The bayonet system also enables the position of the drive device to be locked onto the work unit by rotating the drive device and unlocked by inverse rotation.

According to another characteristic of the invention, the mechanical coupling is of the male/female type.

According to another characteristic of the invention, the drive wheel comprises a female part and the work unit comprises a male part.

According to another characteristic of the invention, the drive wheel comprises a female part cooperating with the male part of the lid of the work unit.

According to another characteristic of the invention, the female part of the drive wheel comprises a space on the lower side for the mechanically coupled accommodation of the work unit in order to transmit the rotational movement.

According to another characteristic of the invention, the space on the lower side of the drive wheel has a hexagonal cross section.

According to another characteristic of the invention, the drive wheel comprises a male part cooperating with the female part of the lid of the work unit.

According to another characteristic of the invention, the drive interface and the male part of the lid or the drive interface and the female part of the lid are immobilized relative to each other, thus forming an integral technical assembly. This technical assembly is capable of being rotated by a motor like that of the self-contained pull string drive device of the appliance according to the invention. The drive interface is thus the central part of this technical assembly rotating freely relative to the lid. This technical assembly is the equivalent of a wheel/hub assembly. The drive interface transmits forces to the drive shaft of the work unit.

According to another characteristic of the invention, the drive interface and the male part or the drive interface and the female part are connected by locking means, for example screws, keys or pins.

According to another characteristic of the invention, the drive interface comprises a housing for receiving the drive shaft positioned in the work unit.

According to another characteristic of the invention, the guide cover 6 has a system for fastening it to the lid of the bowl of the work unit, for example a bayonet fastening system. Advantageously, the fastening system is arranged in the lower part of the guide cover, facing the lid of the bowl. The fastening system enables the user to connect the device to the work unit and disconnect it therefrom. The device can thus be removed or released from the lid. The device is releasably fastened to the interface between the motor part of the appliance and its food-holding part.

According to another characteristic of the invention, the appliance according to the invention comprises a translational locking system for translationally immobilizing the pull string drive device relative to the lid.

Among other things, this translational locking system ensures that the self-contained pull string drive device and the work unit are aligned with the rotation axis A. This thus prevents the drive device and the work unit from deviating from the rotation axis A when the string is pulled or when pressure is exerted on the food while it is processing in the bowl, which would lead to misalignment with the axis of the bowl guide. The pressure from the food is not continuous and is exerted with each pull of the string. The translational locking system allows the work unit to work normally aligned with the rotation axis A.

According to another characteristic of the invention, the translational locking system comprises a stop pin positioned on the lower side of the device, cooperating with a housing for the lid to align the drive wheel and the work unit. This is because pulling the string to operate the food processing arm usually applies a force to the drive device in the direction the string is pulled. The force thus applied tends to shift the drive device and its axis evenly (with each pull of the string) in the direction the string is pulled. This locking system makes it possible to prevent these movements and to stabilize the rotation axis.

According to another characteristic of the invention, the lid has a system for connecting to the bowl of the work unit. This effectively centers the lid on the bowl and keeps the axis of the lid aligned with the axis of the bowl, as well as with the rotation axis A.

According to another characteristic of the invention, the connecting system is a bayonet fastening system or a locking system.

According to another characteristic of the invention, the guide cover of the drive device of the appliance according to the invention may comprise a stop on the handle. In this way, the stop makes it possible to stop the travel of the string, especially when the string is recoiled by the return force of the return spring. The stop can be built directly into the drive device of the appliance according to the invention, and can be, for example, an integral part of the guide cover. According to one variant, the stop will form one end of the guide cover. It could be foreseen that the stop is a separate part of the guide cover.

According to another characteristic of the invention, the string guide, receiving the string, is arranged on the guide cover in a housing of the guide cover. Advantageously, this housing serves as a string exit port and string guide. The string guide is arranged in the guide cover housing which is intended to receive the string guide. The guide cover housing has a shape that is complementary to that of the string guide so as to accommodate the string guide.

According to another characteristic of the invention, the housing of the guide cover of the drive device of the appliance according to the invention is integral with the stop.

According to another characteristic of the invention, the handle of the drive device of the appliance according to the invention is in contact only with the string guide and/or with the stop when the drive device is in the resting phase. The resting phase is the phase in which the string is wound around the drive wheel, the string is fully retracted and the operator is not operating the drive device. In this resting phase, according to a first variant, the handle only touches the string guide, in a second variant the handle only touches the stop, in a third variant the handle simultaneously touches the string guide and the stop. In the first variant, the string guide is protruding from the guide cover housing, so the handle does not contact the guide cover in the resting phase. In the second variant, the string guide is not protruding from the guide cover housing but inserted into the guide cover housing. Thus, the handle contacts the stop of the guide cover in the resting phase. In the third variant, the string guide is not protruding from the guide cover housing but is flush with the guide cover housing. Thus, the handle contacts the stop on the guide cover and the string guide in the resting phase.

According to another characteristic of the invention, the string guide of the drive device of the appliance according to the invention forms a separate part of the stop. When the string moves back and forth, the friction the string causes against the parts it touches, such as the guide cover, generates heat. Therefore, to protect the strings from overheating, a string guide is arranged on the guide cover. Advantageously, the string guide is in the form of a cylindrical ring with an inner space defined by the walls of the ring allowing the string to pass through. Advantageously, the string guide can be made of brass, ceramic or metal, or any material which, when in contact with the string, will not be altered by the heating of the string due to the friction of the string during its movement. Accordingly, the string guide must be made of material that is resistant to heating of the string.

The string can be called cable, pull chain, belt, and can be made of natural material, metal or plastic.

According to another characteristic of the invention, the string guide of the drive device of the appliance according to the invention is removable. Advantageously, the string guide can be disengaged from the guide cover by simple pressure, for example manual, applied by an operator. According to one variant, the string guide is not joined to the guide cover and can be inserted or removed in the guide cover housing by simple pressure, for example by hand, which facilitates assembly.

According to another characteristic of the invention, the guide cover of the drive device of the appliance according to the invention may comprise an offset element to move the handle away in a radial direction relative to the rotation axis and pull the string in a radial direction relative to the rotation axis. Advantageously, this offset element is arranged transversely relative to the rotation axis and makes it possible to receive the string. Advantageously, it makes it possible to keep the string taut in a radial direction relative to the rotation axis. Advantageously, this offset element includes a housing to accommodate the string. It could be foreseen that the offset element is narrow enough to guide the string. Advantageously, this offset element is an integral part of the guide cover. In this case, the guide cover and offset element form a single part. It could also be foreseen that the offset element forms a separate part relative to the guide cover.

According to another characteristic of the invention, the stop of the guide cover of the drive device of the appliance according to the invention is part of the offset element. According to one variant, the stop forms one end of the offset element. Advantageously, it could be foreseen that the stop is a separate part of the offset element and of the guide cover.

According to another characteristic of the invention, the drive wheel of the drive device of the appliance according to the invention may comprise a first anchor point of a first end of the return spring. This first anchor point usually located on the wheel enables the spring to be fastened in cooperation with the second anchor point located on the guide cover. Advantageously, the return spring is a band with a rectangular cross-section, generally elastic, made of metal or tempered steel, wound around the rotation axis on the drive wheel in a cavity. It is usually a spiral spring. The elastic band is wound into the cavity in the shape of a roll with adjoining turns. The winding plane of the return spring is positioned perpendicular to the rotation axis. The first anchor point located by the drive wheel is used to secure the spring and wind it around the rotation axis. Once held in the cavity, the spring is pre-tensioned, meaning under a certain amount of tension.

According to another characteristic of the invention, the return spring of the drive device of the appliance according to the invention comprises a first fastening point that cooperates with the first anchor point; this first fastening point is generally at one end of the spring, in particular the outer end of the spring.

According to another characteristic of the invention, the guide cover of the drive device of the appliance according to the invention may comprise a second anchor point of a second end of the spring. This second anchor point is generally located on the guide cover to immobilize the inner end of the spring. Thus, the return spring or mainspring or barrel spring will be able to store energy when it is taut or under tension, and release it when it relaxes (restoring torque). The energy released is usually transmitted to the work unit.

According to another characteristic of the invention, the return spring of the drive device of the appliance according to the invention may comprise a second fastening point that cooperates with the second anchor point; this second fastening point is generally at one end of the spring, in particular the inner end of the spring.

The drive device of the appliance according to the invention comprises a drive wheel. According to one characteristic of the invention, the drive wheel of the drive device of the appliance according to the invention comprises a groove to receive the string. Advantageously, this drive wheel is a take-up drum comprising a groove in which the string fits by winding around the rotation axis.

According to one characteristic of the invention, the drive wheel of the drive device of the appliance according to the invention may comprise a cavity intended to receive the return spring. Advantageously, the cavity is arranged so as to place the return spring transversely to the rotation axis. Advantageously, the cavity has a shape that is complementary to that of the pre-tensioned spring, such as a cylinder.

Advantageously, the string is wound in the groove of the drive wheel, counter-clockwise relative to the rotation axis, and the return spring is arranged in the cavity of the drive wheel wound clockwise relative to the rotation axis. It could be foreseen that the string is wound in the groove of the drive wheel, clockwise relative to the rotation axis, and the return spring is arranged in the cavity of the drive wheel, wound counter-clockwise relative to the rotation axis.

According to another characteristic of the invention, the drive wheel of the drive device of the appliance according to the invention can be rotated relative to the guide cover. According to another characteristic of the invention, the guide cover may be fixed relative to the drive wheel of the drive device according to the invention.

According to one characteristic of the invention, the drive wheel of the drive device of the appliance according to the invention may comprise a means of enabling the work unit to be mechanically coupled so as to transmit the rotational movement. This means may have a specific male or female shape intended to transmit the movement.

According to one characteristic of the invention, the drive wheel of the drive device of the appliance according to the invention may comprise a space on the lower side for the mechanically coupled accommodation of the work unit in order to transmit the rotational movement. Advantageously, this space on the lower side of the drive wheel has a hexagonal cross section. Advantageously this space on the lower side of the drive wheel has a shape of a cylinder with a hexagonal cross section. Advantageously, this space makes it possible to receive a drive shaft and to cooperate with this drive shaft to transmit a rotational movement.

According to one characteristic of the invention, the device of the appliance according to the invention can be arranged coaxially relative to the rotation axis A between an upper part and a lower part, these two parts being elements of a lid. According to one characteristic of the invention, the handle of the device according to the invention is never in contact with these upper or lower parts in the resting phase of the drive device. “Coaxially” within the meaning of the invention denotes that the parts are aligned on the same axis, without necessarily running through the geometric center of the parts.

The invention also relates to a kitchen appliance. Examples include salad spinners, choppers, potato mashers, juicers or blenders or any other appliance that requires a non-electric, manually operated, self-retracting cable reel to transmit movement from one part to another by pulling a cable or string.

According to another variant of the invention, the drive device of the appliance according to the invention can either form the base of the kitchen appliance or be housed in the base of the kitchen appliance.

The purposes, aspects and advantages of the present invention will be better understood from the following description of specific embodiments of the invention provided as non-limiting examples, with reference to the appended drawings in which:

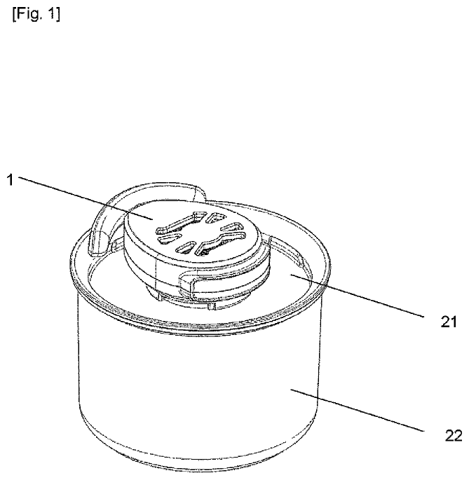

FIG. 1 is a perspective view of a kitchen appliance according to the invention, of the chopper type, comprising a drive device in its resting phase; the device is positioned on the lid of the bowl of the work unit according to a specific embodiment of the invention.

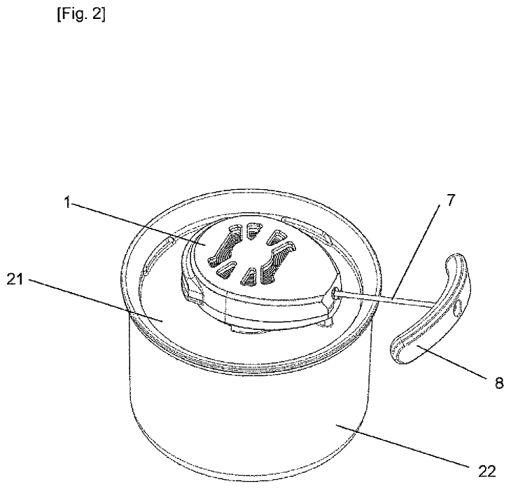

FIG. 2 is a perspective view of the appliance in FIG. 1 showing the string of the drive device when pulled out, in a working phase.

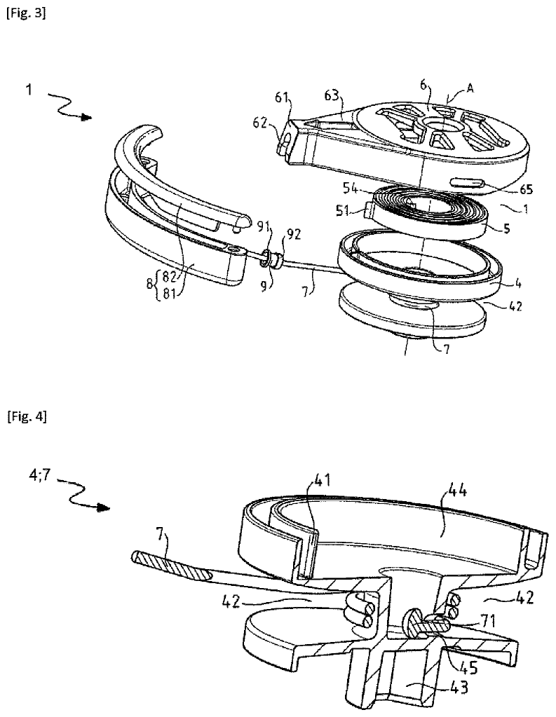

FIG. 3 is an exploded perspective view of a drive device of the appliance according to the invention a specific embodiment of the invention [sic].

FIG. 4 is a cross-sectional perspective view of the drive wheel and of the string of the device in FIG. 3.

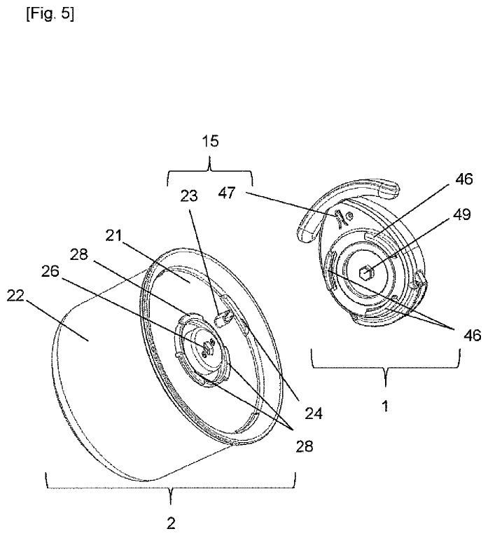

FIG. 5 is a perspective view of a kitchen appliance according to the invention, featuring a drive wheel comprising a male part and a work unit comprising a female part.

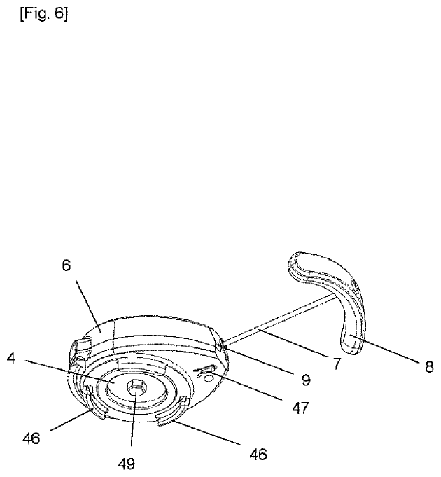

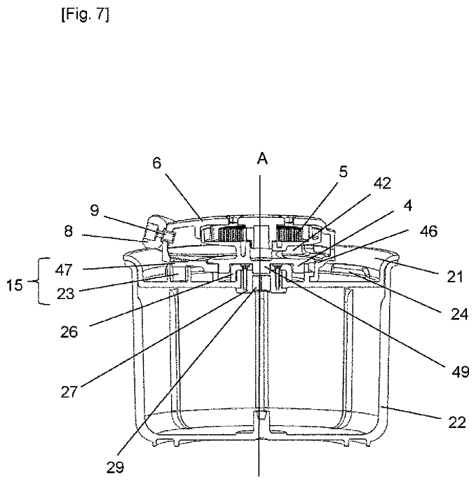

FIG. 6 is a perspective view of the drive device used in FIG. 5 shown with its string pulled out, in a working phase.

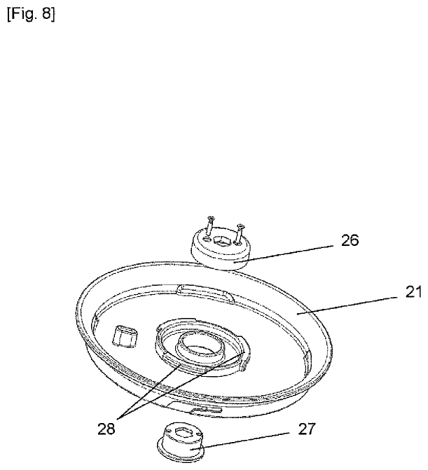

FIG. 7 is a cross-sectional view of the kitchen appliance shown in FIG. 5, with its drive device positioned on the work unit.

FIG. 8 is a perspective view of the lid of the work unit of the appliance according to the invention shown in FIG. 5.

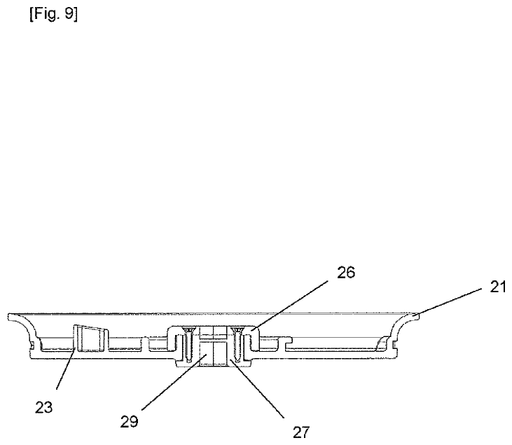

FIG. 9 is a cross-sectional view of the lid of the work unit of the appliance according to the invention shown in FIG. 5.

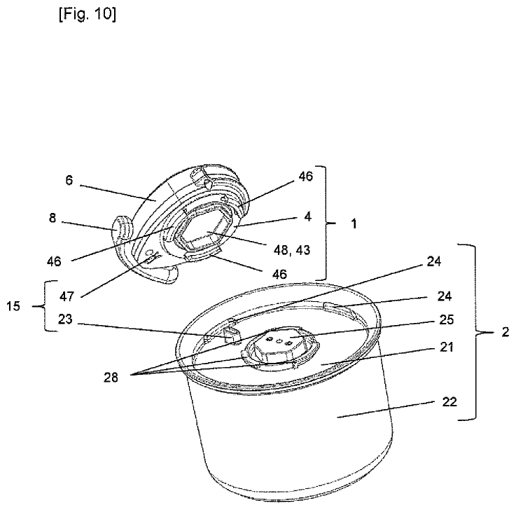

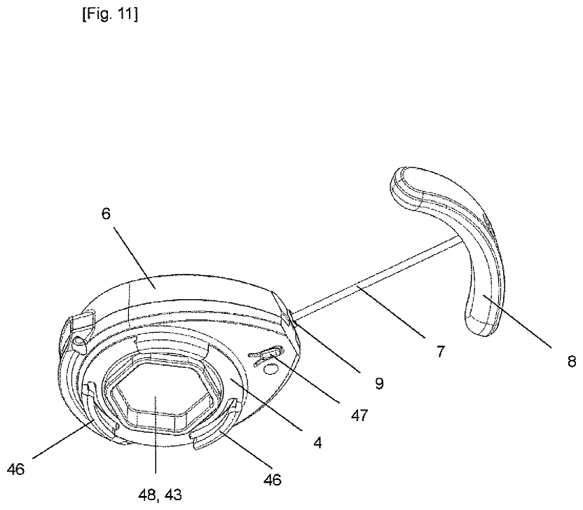

FIG. 10 is a perspective view of a kitchen appliance according to the invention, with a drive wheel comprising a female part and the work unit comprising a male part.

FIG. 11 is a perspective view of the drive device used in FIG. 10 shown with its string pulled out, in a working phase.

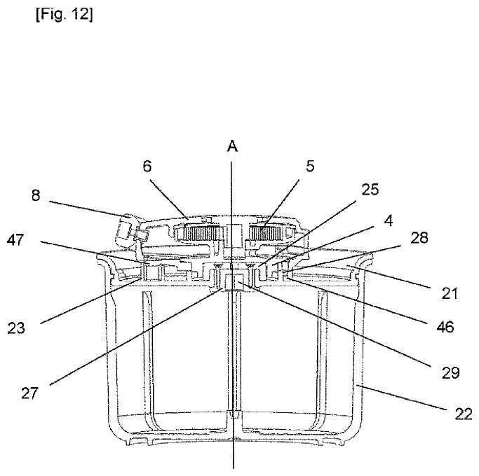

FIG. 12 is a cross-sectional view of the kitchen appliance shown in FIG. 10, with its drive device positioned on the work unit.

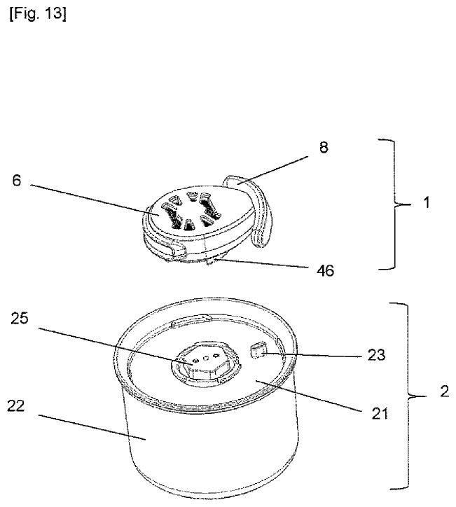

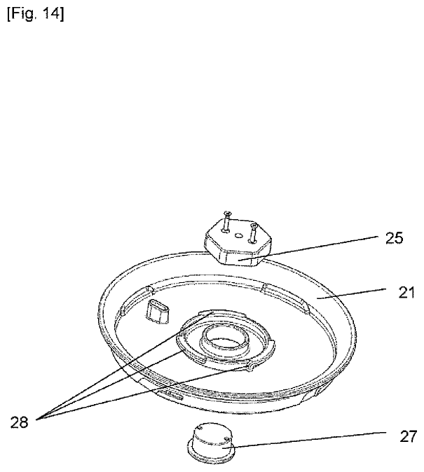

FIG. 13 is a perspective view of top of the device shown in FIG. 10.

FIG. 14 is a perspective view of the lid of the work unit according to the invention shown in FIG. 10.

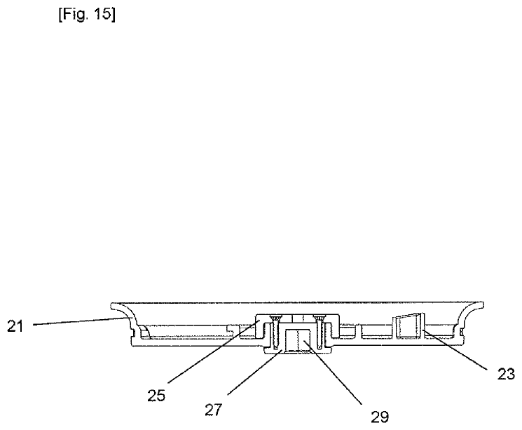

FIG. 15 is a cross-sectional view of the lid of the work unit according to the invention shown in FIG. 10.

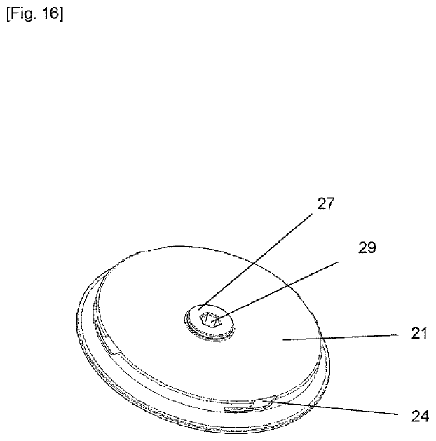

FIG. 16 is a perspective view of the underside of the lid of the work unit of the appliance according to the invention in FIG. 15 or in FIG. 9.

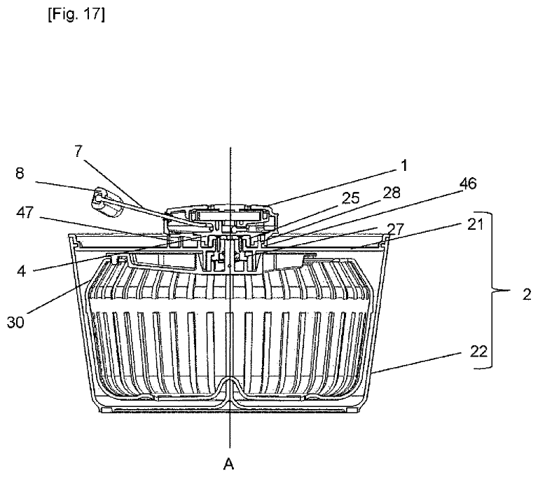

FIG. 17 is a cross-sectional view of a kitchen appliance according to the invention, of the salad spinner type, comprising a drive device pulled out in a working phase; the device is positioned on the lid of the bowl of the work unit according to a specific embodiment of the invention.

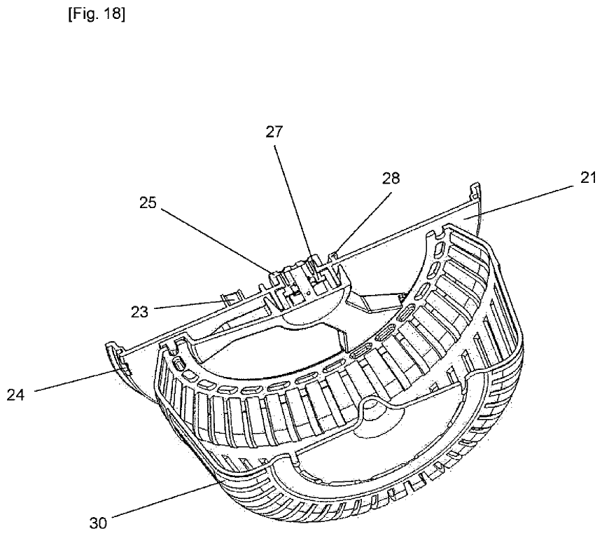

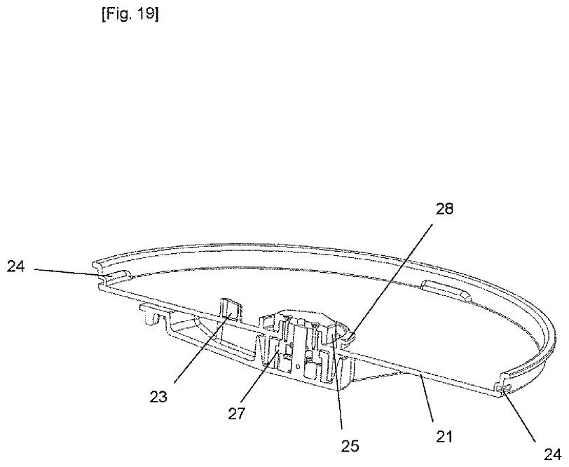

FIG. 18 is a partial perspective view of the appliance in FIG. 17 showing the drive device with its string pulled out.

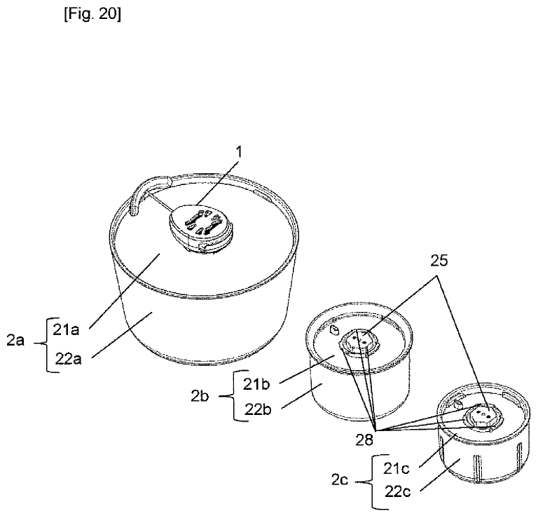

FIG. 19 is a partial perspective view of the lid of the appliance in FIG. 17.

FIG. 20 is a perspective view of 3 kitchen appliances according to the invention in which the bowl of the work unit has a different volume and in which the lid of the work unit has a different diameter. All 3 appliances are shown on the same scale. The appliance with the largest volume appearing on the leftmost side of FIG. 20 is the one shown in detail in FIGS. 17 to 19. The other 2 appliances with smaller volumes appearing on the rightmost side of FIG. 20 are the ones shown in detail in FIGS. 10 to 16. The drive device is shown fastened to the appliance with the largest volume appearing on the leftmost side of FIG. 20.

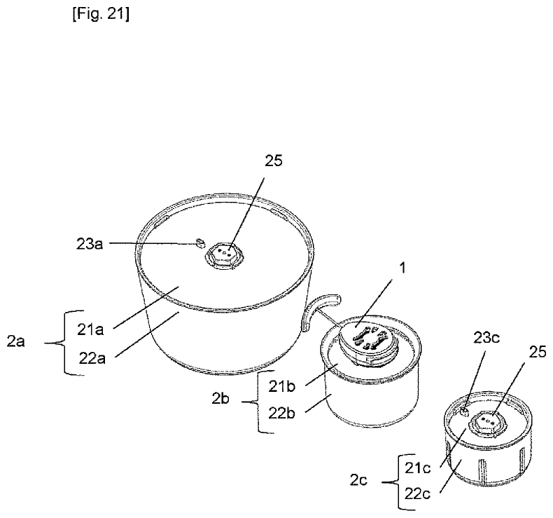

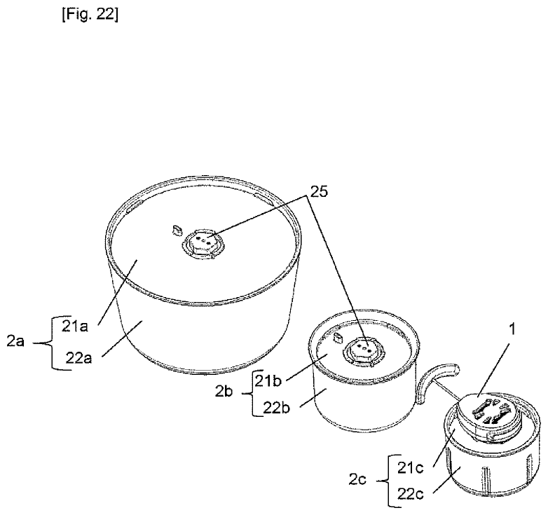

FIG. 21 is a perspective view of the 3 kitchen appliances according to the invention in FIG. 20, shown with the drive device fastened to the middle appliance.

FIG. 22 is a perspective view of the 3 kitchen appliances according to the invention in FIGS. 20 and 21, shown with the drive device fastened to the rightmost appliance.

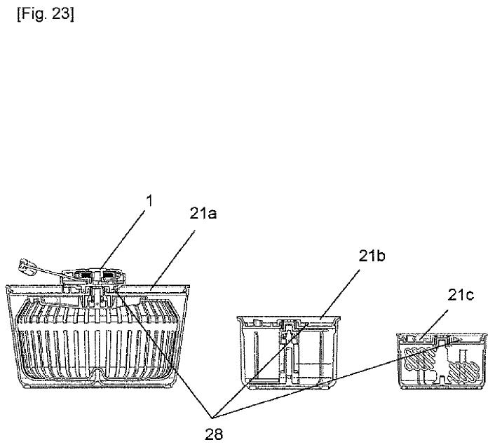

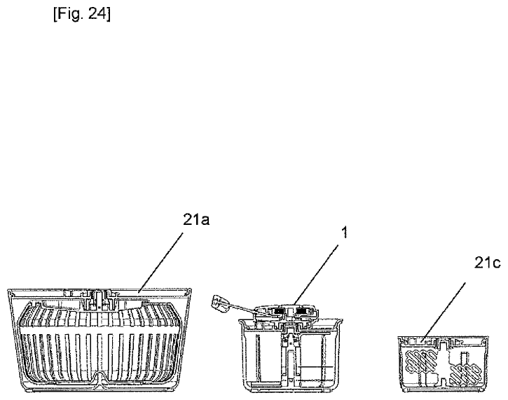

FIG. 23 is a cross-sectional view of FIG. 20.

FIG. 24 is a cross-sectional view of FIG. 21.

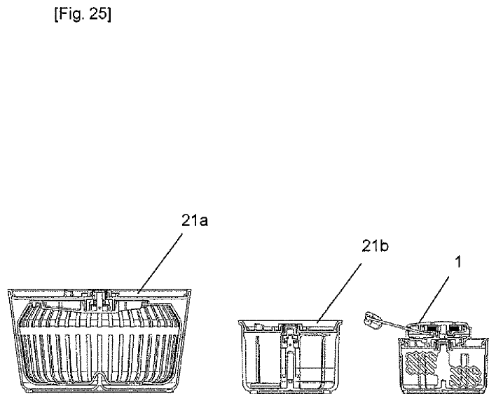

FIG. 25 is a cross-sectional view of FIG. 22.

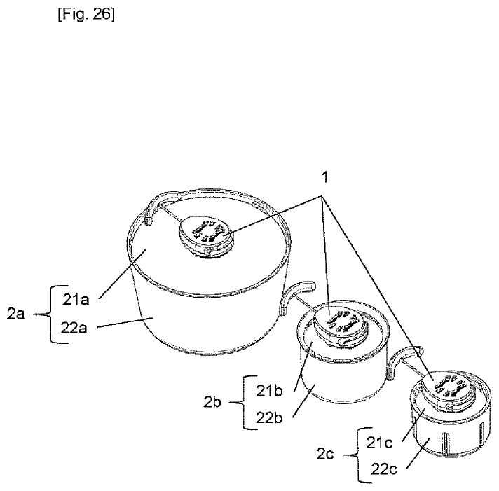

FIG. 26 is a perspective view of the 3 kitchen appliances according to the invention in FIG. 20 shown to the same scale, each with the same drive device attached to the lid of the bowl of the appliance.

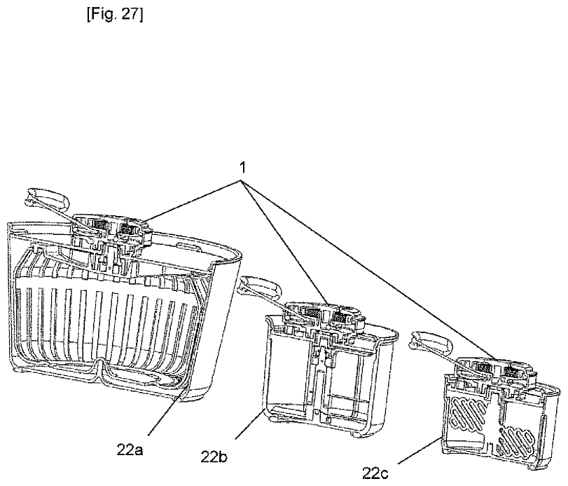

FIG. 27 is a partial perspective view of the 3 kitchen appliances according to the invention in FIG. 26.

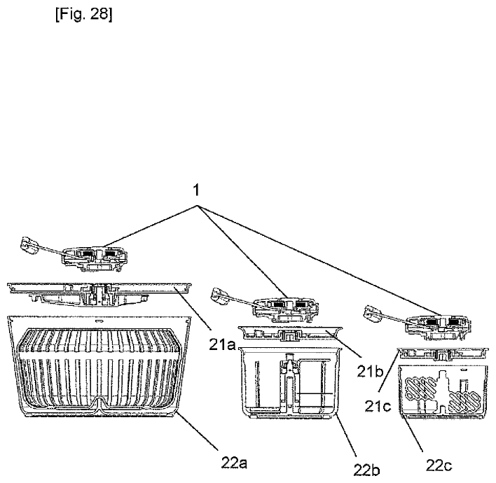

FIG. 28 is a cross-sectional view of the 3 kitchen appliances according to the invention in FIG. 26 shown with the 3 parts that make up the appliance according to the invention, namely the bowl, the lid and the drive device.

FIG. 1 shows a kitchen appliance according to the invention which is a chopper and in which the work unit 2 comprises cutting blades. The kitchen appliance comprises a drive device 1 in its resting phase, meaning that no force is being transmitted to generate a movement. The device 1 is arranged on the lid 21 of the bowl 22 of the work unit 2.

FIG. 2 shows the same kitchen appliance as FIG. 1, shown in one of its use situations with the handle pulled and the string unrolled and tensioned.

FIG. 3 shows an exploded perspective view of the drive device 1 according to a specific embodiment of the invention. The guide cover 6 is arranged transversely to the rotation axis A. The guide cover 6 comprises an offset element 63 which is not arranged coaxially with the rotation axis A but is offset relative to the rotation axis A. The offset element 63 moves the string away from the stop position relative to the rotation axis A and extends the guide cover 6 in a plane transverse to the rotation axis A. The offset element 63 is optional and may be removed so the string stop position would be closest to the rotation axis A. The guide cover 6 comprises a stop 61 that stops the string return travel when it is recoiled by the return spring 5. This is a flat surface arranged transversely to the travel of the string. The guide cover 6 comprises a housing 62 capable of receiving the string guide 9. The housing 62 is in the shape of a keyhole that is complementary to the shape of the string guide, allowing the string guide 9 to fit into the housing 62. The string guide 9 comprises 2 flanges, a front flange 91 and a rear flange 92 relative to the distance from the rotation axis A. The flanges 91 and 92 allow the string guide to remain stationary in its housing 62 in a direction transverse to the rotation axis A and enable the string guide 9 to remain mobile in the same direction as the rotation axis A. The flanges 91 and 92 keep the string guide 9 in place as the string 7 moves back and forth, without being dragged by the movement of the string. The drive device 1 comprises a handle 8, comprising 2 pieces, the base 81 of the handle and the cover 82 of the handle. The handle 8 has a curved shape that conforms to the round shape of the lid 10. The return spring 5 is wound around the rotation axis A.

FIG. 4 is a cross-sectional perspective view of the drive wheel 4 and of the string 7 of the device in FIG. 3. The first step in assembling the appliance according to the invention is to form a first knot 71 at one end of the string 7. Then the other end of the string (unknotted) is inserted into a string hole 45. The string hole 45 has a cross-section that is smaller than the area of the smallest cross-section of the knot 71. The string 7 is pulled until knot 71 is held by the walls around the string hole 45. Then the string 7 is wound counterclockwise partially into a groove 42. The string 7 is thus fastened to the drive wheel 4 and the knot 71 makes it possible to secure the string.

FIG. 5 is a perspective view of a kitchen appliance according to the invention, featuring a drive wheel 4 comprising a male part 49 and a work unit 2 comprising a female part 26. The appliance according to the invention has a work unit 2 comprising a bowl 22 and a lid 21. The lid 21 has a translational locking system 15 comprising a protruding stop pin 47 positioned on the lower side of the device 1 cooperating with a housing 23 for the lid 21 to align the drive wheel 4 and the work unit 2 according to the axis of rotation A. The male part 49 has a hexagonal cross section on the lower side of the drive wheel 4. The female part 26 on the upper side of the lid 21 has a shape that is complementary to the male part 49 so as to mechanically cooperate and transmit a rotational movement. The fastening system 46 of the guide cover 6 is a bayonet fastening system, in which the bayonets cooperate and snap onto the fastening members 28 of the lid 21. Thus, the guide cover 6 is locked relative to the lid 21, preventing the device (1) from turning relative to the lid (21). The fastening system (46; 28) enables the drive device 1 to be unlocked and released from the lid 21.

FIG. 6 is a perspective view of the drive device 1 used in FIG. 5 shown with its string 7 pulled out, in a working phase.

FIG. 7 is a cross-sectional view of the kitchen appliance shown in FIG. 5, with its drive device positioned on the work unit. The drive interface 27 is shown joined to the female part 26. The bayonets of the fastening system 46 are snapped onto the lid 21. The lid 21 is locked on the bowl 22 by means of the connection system 24 which is a second bayonet fastening system, different from the bayonets of the fastening system 46.

FIG. 8 is a perspective view of the lid 21 of the work unit of the appliance according to the invention shown in FIG. 5. The drive interface 27 is a wheel that fits into the female part 26 with the complementary shape. Two screws are shown on the female part 26 to secure it to the drive interface 27. The three fastening members 28 are shown free of any cooperation.

FIG. 9 is a cross-sectional view of the lid 21 of the work unit of the appliance according to the invention shown in FIG. 8.

FIG. 10 is a perspective view of a kitchen appliance according to the invention, with a drive wheel 4 comprising a female part 48 and the work unit comprising a male part 25. The appliance according to the invention has a work unit 2 comprising a bowl 22 and a lid 21. The lid 21 has a translational locking system 15 comprising a protruding stop pin 47 positioned on the lower side of the device 1 cooperating with a housing 23 for the lid 21 to align the drive wheel 4 and the work unit 2 according to the rotation axis A. The male part 25 has a hexagonal cross section on the upper side of the lid 21. The female part 48 on the lower side of the drive wheel 4 is a space 43 with a shape that is complementary to the male part 49. The fastening system 46 from the guide cover 6 to the lid 21 is a bayonet fastening system, in which the bayonets snap onto the fastening members 28 of the lid 21 in order to temporarily keep the drive device 1 on the lid 21.

FIG. 11 is a perspective view of the drive device 1 used in FIG. 8 shown with its string 7 pulled out, in a working phase.

FIG. 12 is a cross-sectional view of the kitchen appliance shown in FIG. 8, with its drive device 1 positioned on the work unit 2. The drive interface 27 is shown joined to the male part 25. The bayonets of the fastening system 46 are snapped onto the lid 21. The lid 21 is locked on the bowl 22 by means of the connection system 24 which is a second bayonet fastening system, different from the bayonets of the fastening system 46. The fastening system 46 cooperates with the fastening member 28 to temporarily secure the drive device 1 to the lid 21.

FIG. 13 is a perspective view of the top of the appliance shown in FIG. 8.

FIG. 14 is a perspective view of the lid 21 of the work unit of the appliance according to the invention shown in FIG. 10. The drive interface 27 is a wheel that fits into the male part 25 with the complementary shape. Two screws are shown on the male part 25 to secure it to the drive interface 27. The three fastening members 28 of the lid 21 are shown free of any cooperation.

FIG. 15 is a cross-sectional view of the lid 21 of the work unit of the appliance according to the invention shown in FIG. 14.

FIG. 16 is a perspective view of the underside of the lid 21 of the work unit of the appliance according to the invention showing the drive interface 27 comprising a housing for receiving the drive shaft 29.

FIGS. 17, 18 and 19 show a kitchen appliance of the salad spinner type, with its drive device 1 positioned on the working unit 2 so as to rotate a basket 30. The drive interface 27 is a wheel that fits into the male part 25 with the complementary shape. Two screws are shown on the male part 25 to secure it to the drive interface 27. The bayonets of the fastening system 46 are engaged on the fastening member 28 of the lid 21. The lid 21 is locked on the bowl 22 by means of the connection system 24 which is a second bayonet fastening system, different from the bayonets of the fastening system 46. The fastening system 46 cooperates with the fastening member 28 to temporarily secure the drive device 1 to the lid 21. The lid 21 has a translational locking system 15 comprising a protruding stop pin 47 positioned on the lower side of the device 1 cooperating with a housing 23 for the lid 21 to align the drive wheel 4 and the work unit 2 according to the rotation axis A.

FIGS. 20 to 24 show 3 kitchen appliances according to the invention, whose work unit bowls 22a, 22b and 22c have different volumes. The largest bowl is bowl 22a, which is the salad spinner bowl shown in FIGS. 17 to 19. The drive device 1 used to drive the work units 2a, 2b and 2c is the same. The 3 appliances have lids 21a, 21b and 21c with different diameters. The 3 appliances are shown on the same scale in all 3 FIGS. 20, 21 and 22. The appliance with the largest volume appearing on the leftmost side of FIG. 20 is the one shown in detail in FIGS. 17 to 19. The other 2 appliances with smaller volumes appearing on the rightmost side of FIG. 20 are the ones shown in detail in FIGS. 10 to 16. The drive device is shown fastened to the appliance with the largest volume appearing on the leftmost side of FIG. 20.

The male part 25 of the work unit 2a, 2b or 2c is the same part, of the same size and diameter and with the same function shown to the same scale. The male part 25 of the lid of the work unit 2a, 2b or 2c cooperates with the female part of the driving wheel of the device 1. Thus the same drive device 1 is self-contained and can be easily adapted to separately drive different work units 2a, 2b and 2c. Accordingly, the device 1 of the appliance according to the invention is separate and ready to operate at any time. The drive device 1 is a self-contained subset relative to the work unit, and is releasable, meaning that it is configured to be moveable from one kitchen appliance to another, or even replaceable or repairable. Indeed, it could be foreseen that the pull string drive device 1 of the appliance according to the invention could be released and then moved from one lid to another lid, by releasing it from the bowl lid, without any action on the parts of the drive mechanism.

FIGS. 26 to 28 show the 3 kitchen appliances according to the invention in FIG. 20, shown to the same scale each with the same drive device 1 designed and configured to be attached to work units of different sizes, volumes and uses, namely 2a (salad spinner), 2b (chopper) and 2c (blender, emulsifier).

FIG. 28 shows the 3 appliances, demonstrating that the 3 parts that make up the appliance according to the invention, namely the bowl 22, the lid 21 and the drive device 1, are separate from each other, the drive device 1 being identical.

Although the invention has been described in relation to particular exemplary embodiments and applications, it is obviously in no way limited thereto.

Changes can still be made, particularly with regard to the arrangement and composition of the various elements or by substituting equivalent techniques, without departing from the scope of protection of the invention.

1. A kitchen appliance comprising a self-contained pull string drive device and a work unit; the device is configured for manually rotating a work unit around a rotation axis by pulling a string transversely to the rotation axis A,
the device comprising a drive wheel, a return spring, all positioned coaxially relative to the rotation axis A, a string, wherein one end of the string is wound around the drive wheel and other end of the string is connected to a handle;
the work unit comprising a lid closing a bowl;
wherein the pull string drive device is configured to be detachable from the lid of the bowl and the lid comprises a male or a female part joined to a drive interface, so as to cooperate with the drive wheel by mechanical coupling in order to transmit a rotational movement from the device to the work unit.

2. The kitchen appliance according to claim 1, wherein the pull string drive device is configured to be releasable, attachable or detachable from the lid of the bowl.

3. The kitchen appliance according to claim 1, wherein the appliance has a fastening system enabling the device to be temporarily and reversibly fastened to the lid closing the bowl of the work unit.

4. The kitchen appliance according to claim 3, wherein the fastening system is a bayonet fastening system.

5. The kitchen appliance according to claim 1, wherein the mechanical coupling is of the male/female type.

6. The kitchen appliance according claim 1, wherein the drive wheel comprises a female part cooperating with the male part of the lid of the work unit.

7. The kitchen appliance according to claim 6, wherein the female part comprises a space on a lower side for the mechanically coupled accommodation of the work unit in order to transmit the rotational movement.

8. The kitchen appliance according to claim 5, wherein the space on the lower side of the drive wheel has a hexagonal cross section.

9. The kitchen appliance according to claim 1, wherein the drive wheel comprises a male part cooperating with the female part of the lid of the work unit.

10. The kitchen appliance according to claim 1, wherein the drive interface and the male part or the drive interface and the female part are immobilized relative to each other.

11. The kitchen appliance according to claim 10, wherein the drive interface and the male part or the drive interface and the female part are connected by locking means.

12. The kitchen appliance according to claim 1, wherein the drive interface comprises a housing for receiving the drive shaft positioned in the work unit.

13. The kitchen appliance according to claim 1, further comprising a translational locking system for translationally immobilizing the pull string drive device relative to the lid.

14. The kitchen appliance according to claim 12, wherein the translational locking system comprises a stop pin positioned on a lower side of the device and configured to cooperate with a housing for the lid to align the drive wheel and the work unit.

15. The kitchen appliance according to claim 4, wherein the lid comprises a system for connecting to the bowl of the work unit.

16. The kitchen appliance according to claim 10, wherein the drive interface and the male part or the drive interface and the female part are connected by screws, keys, or pins.

17. The kitchen appliance according to claim 10, wherein the drive interface and the male part or the drive interface and the female part are connected by keys.

18. The kitchen appliance according to claim 10, wherein the drive interface and the male part or the drive interface and the female part are connected by pins.

19. The kitchen appliance according to claim 4, wherein the lid comprises a bayonet fastening system for connecting to the bowl of the work unit.

20. The kitchen appliance according to claim 4, wherein the lid comprises a locking system for connecting to the bowl of the work unit.
